(19) United States
(12) Patent Application Publication
(10) Pub. No.: US 2019/0291150 A1
(43) Pub. Date: Sep. 26, 2019

(54) DUST CONTAINMENT APPARATUS

(71) Applicant: ipcGUARD Ltd., Courtenay (CA)

(72) Inventors: Derek James Smith, Courtenay (CA); Kurt Ronald Latimore, Snohomish, WA (US)

(73) Assignee: ipcGUARD Ltd., Courtenay (CA)

(21) Appl. No.: 16/360,829

(22) Filed: Mar. 21, 2019

Related U.S. Application Data
(60) Provisional application No. 62/772,530, filed on Nov. 28, 2018.

(30) Foreign Application Priority Data
Mar. 26, 2018 (CA) 2999314
Feb. 4, 2019 (CA) 3032851

(51) Int. Cl. B08B 15/02

(52) U.S. Cl. CPC B08B 15/02

(57) ABSTRACT

A dust containment apparatus includes a housing that includes an opening and defines an internal volume. A housing seal is provided along an edge of the opening for sealing the housing against a work surface to be engaged with the housing. At least two hand ports are provided in the housing for receiving a user's hands. At least one of the hand ports includes a deformable hand port seal for at least partially sealing against the user's arm or hand when inserted through the hand port into the internal volume. The deformable hand port seal includes an aperture formed therein for allowing the user's hand to access the internal volume.

### CROSS REFERENCE TO RELATED APPLICATIONS

The present application claims the benefit of U.S. Provisional Application No. 62/772,530, filed Nov. 28, 2018 and claims priority to Canadian Patent Application Nos. 2,999,314, filed Mar. 26, 2018 and 3,032,851, filed Feb. 4, 2019. All of these applications are incorporated herein by reference.

### FIELD

The present disclosure relates to a dust containment apparatus that may be used, for example, in hospitals.

### BACKGROUND

Dust-generating construction activities in operating healthcare facilities may be subject to infection control regulations. For example, construction activities in operating Canadian healthcare facilities are regulated under CSA Z317.13-17 which requires the containment of airborne dust that can transmit pathogens from one patient to another. Typically, hoarding is used to shield the construction area and prevent the spread of dust and other airborne contaminants. In particular, polyethylene plastic sheeting, such as Visqueen™, may be used to form a negative-pressure boundary behind which the carpenter can perform the dust-generating work.

However, hoarding generally requires hours of assembly, clean-up, and teardown. This displaces patients and is labour-intensive, and only a fraction of the total labour is expended on repairs. Furthermore, P3 (Public/Private Partnership) facilities levy fines for facility downtime. As a result, facility managers typically defer beneficial repairs leading to repair backlogs, deteriorating facility quality, and lower staff morale as work goes undone.

There is therefore a need in the art for more efficient means of containing dust during repair, maintenance, or other construction work.

### SUMMARY

According to a first aspect of the disclosure, there is provided a dust containment apparatus comprising: a housing comprising an opening and defining an internal volume; a housing seal provided along an edge of the opening for sealing the housing against a work surface to be engaged with the housing; and at least two hand ports provided in the housing for receiving a user's hands, wherein at least one of the hand ports comprises a deformable hand port seal for at least partially sealing against the user's arm or hand when inserted through the hand port into the internal volume, and wherein the deformable hand port seal comprises an aperture formed therein for allowing the user's hand to access the internal volume.

Thus, by using a dust containment apparatus as described above, the need for special clothing, respirators, dust masks, face and eye shields, as well as anterooms, is reduced.

The dust containment apparatus may be suitable for users to perform CSA Z317.13-17 Preventative Measures I, II, III, or IV, during Construction Activity Types A or B. The dust containment apparatus may be a vessel per CSA Z317.13-17 § 6.6.1.2(c)(iv).

The dust containment apparatus may create a negative-pressure vacuum environment at the source of construction dust, may enable a maintenance technician to efficiently complete timely and localized repairs.

The housing may further comprise a vacuum port for connecting to a vacuum device. The apparatus may further comprise a vacuum conduit for connecting to the vacuum port within the internal volume.

The apparatus may further comprise a vacuum device for connecting to the vacuum port.

The apparatus may further comprise a pressure sensor for reading a pressure within the internal volume. The apparatus may further comprise a display for displaying to the user the pressure read by the pressure sensor.

The housing seal may comprise a flange extending from the housing.

The housing seal may comprise a closed-cell foam.

The housing may be attached to an arm for supporting the housing in engagement with a work surface. The housing may be removably attached to the arm.

The arm may be articulated.

The arm may be supported by a movable platform for positioning the housing in engagement with a work surface.

The aperture may comprise multiple slits formed within the deformable hand port seal. The multiple slits may intersect at a common point.

The hand ports may be removable from the housing.

The apparatus may further comprise an adhesive for assisting the housing seal to seal against a work surface. The adhesive may comprise tape.

The apparatus may further comprise a vacuum limiter for limiting a differential pressure between the internal volume and an exterior of the housing. For example, the apparatus may further comprise a vacuum limiter configured to open in response to an increase in the difference between atmospheric pressure and a pressure within the internal volume. The vacuum limiter may be comprised in the vacuum port.

According to a further aspect of the disclosure, there is provided a method of performing work on a work surface, comprising: providing any of the above-described dust containment apparatuses; engaging the opening with a work surface such that the housing seal seals against the work surface; inserting one or more tools through the hand ports and into the internal volume; performing work on the work surface using the one or more tools; and vacuuming dust generated from the work by using a vacuum conduit coupled to the vacuum port within the internal volume.

The vacuuming may be performed simultaneously to the work.

The method may further comprise, prior to performing the work, generating a vacuum within the internal volume by using a vacuum device coupled to the vacuum port.

The method may further comprise applying an adhesive to the housing seal to assist the seal between the housing seal and the work surface.

The foregoing and other objects, features, and advantages of the invention will become more apparent from the following detailed description, which proceeds with reference to the accompanying figures.

### BRIEF DESCRIPTION OF THE DRAWINGS

Embodiments of the disclosure will now be described in detail in conjunction with the accompanying drawings of which:

FIG. 1 shows a dust containment apparatus according to embodiments of the disclosure;

FIG. 2 shows the internal volume of a dust containment apparatus according to embodiments of the disclosure;

FIG. 3 shows a dust containment apparatus according to embodiments of the disclosure;

FIG. 4 shows an exploded view of a dust containment apparatus according to embodiments of the disclosure; and

FIG. 5 is a flow diagram of an exemplary method of performing work on a work surface, according to embodiments of the disclosure.

### DETAILED DESCRIPTION

The present disclosure seeks to provide an improved dust containment apparatus, and a method of using a dust containment apparatus. While various embodiments of the disclosure are described below, the disclosure is not limited to these embodiments, and variations of these embodiments may well fall within the scope of the disclosure which is to be limited only by the appended claims.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through one or more intermediate elements or devices via an electrical element, electrical signal or a mechanical element depending on the particular context. The term “and/or” herein when used in association with a list of items means any one or more of the items comprising that list.

As used herein, a reference to “about” or “approximately” a number or to being “substantially” equal to a number means being within +/−10% of that number. Generally, according to embodiments of the disclosure, there is described a dust containment apparatus that may be used, for example, in hospitals to assist in preventing the spread of dust and contaminants during repair, maintenance, or other construction work (hereinafter, “maintenance work”). The dust containment apparatus comprises a housing, which may be in the shape a box, defining an internal volume and having an opening formed in the housing. For example, the box may have a face removed to thereby provide the opening. A housing seal, which may take the form of a flange, is provided along an edge of the opening and is used to create a seal between the housing and a work surface against which the housing is engaged. The housing may include a vacuum port for coupling to a vacuum device. A negative pressure may therefore be generated within the internal volume.

The housing further includes a pair of hand ports for allowing a user to introduce their hands within the internal volume and carry out work on the work surface. The hand ports include apertures formed therein so that a user may introduce tools within the internal volume. With one hand, the user may operate a tool to carry out work on the work surface, and with the other hand the user may operate a vacuum conduit provided within the internal volume and coupled to the vacuum port, and thereby simultaneously vacuum dust generated during the maintenance work. At least one of the hand ports includes a deformable seal that creates at least a partial seal between the hand port and the user's arm during the maintenance work. Thus, the spread of dust and contaminants during the maintenance work may be minimized.

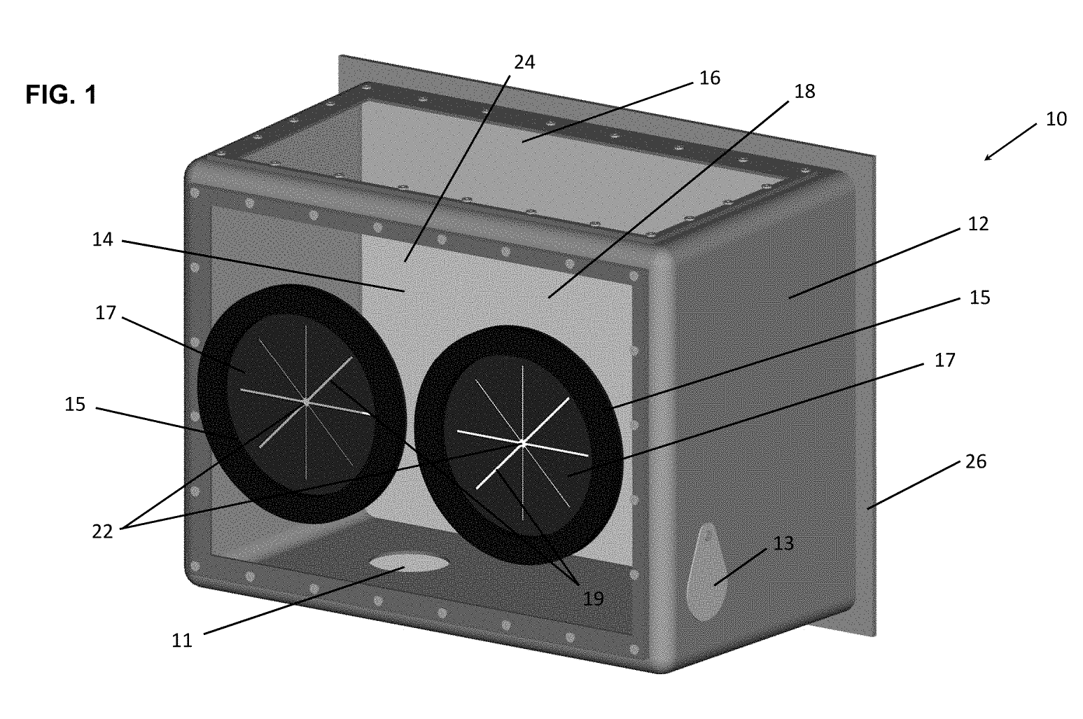

Turning to FIG. 1, there is shown a dust containment apparatus 10 according to embodiments of the disclosure. Dust containment apparatus 10 comprises a generally hollow, box-shaped housing 12. In some embodiments, housing 12 does not have to be box-shaped, and may comprise other suitable shapes as would be recognized by a person skilled in the art. Housing 12 includes front and top transparent panels 14 and 16 for allowing a user to see into an internal volume 18 defined by housing 12. Housing 12 further includes a vacuum port 11 formed within a lower side of housing 12, and a secondary air inlet, or vacuum limiter 13, in housing 12 for limiting maximum vacuum levels generated within internal volume 18. In some embodiments, vacuum limiter 13 may be provided within vacuum port 11. Vacuum port 11 is configured to be coupled to a vacuum device, such as a vacuum cleaner.

Within front transparent panel 14 of housing 12, two hand ports 15 are provided. Each hand port 15 comprises a deformable seal 17 formed of moulded silicone, although other suitable materials fall within the scope of the disclosure. Each deformable seal 17 comprises an aperture 22 formed therein. Each aperture 22 comprises three or four slits or tines 19 intersecting at a common point. As will be recognized by a person skilled in the art, the number of slits within each deformable seal 17 may be varied, as well as the shape of aperture 22. Hand ports 15 are removable from housing 12 so that, for example, hand ports 15 may be replaced or cleaned. According to some embodiments, each deformable seal 17 may comprise one or more radial ribs (not shown) for reinforcing hand ports 15 and to reduce undesirable vibrations of hand ports 15 during operation of a vacuum device coupled to vacuum port 11. The one or more radial ribs may be positioned on the side of hand ports 15 that faces internal volume 18.

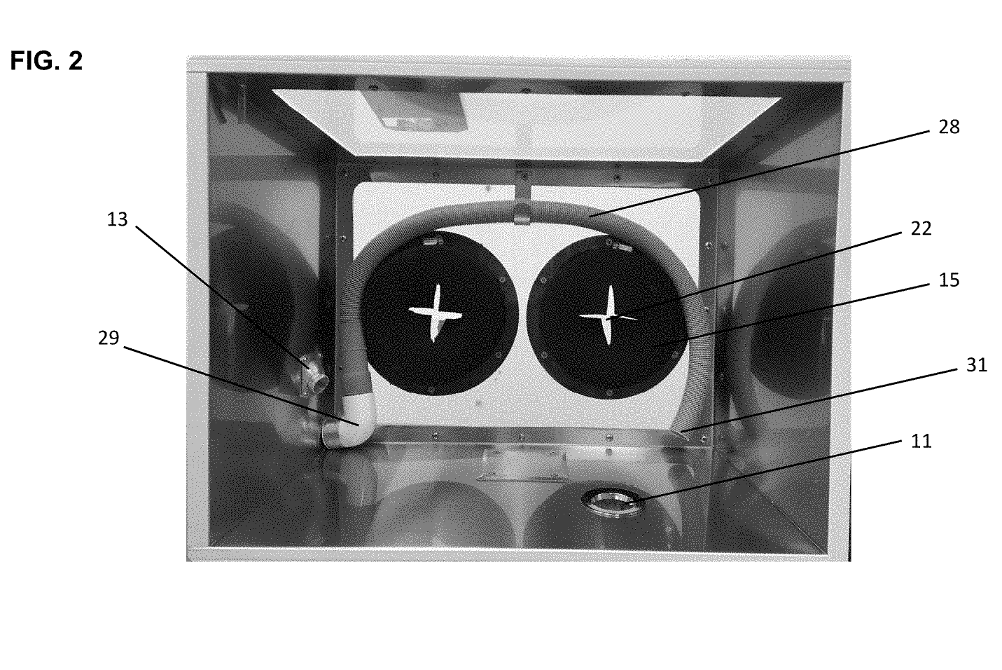

Housing 12 further comprises an open rear side defining an opening 24. Housing 12 further includes a housing seal 26 provided along an edge of opening 24. Housing seal 26 comprises a flange extending away from housing 12 at approximately a right angle thereto. In use, housing seal 26 is engaged with a work surface on which a user wishes to perform maintenance work. Housing seal 26 is formed of closed-cell, sound-proof, weather stripping foam insulation tape, although, as would be recognized by the skilled person, housing seal 26 may be formed of other suitable materials for providing a seal between housing 12 and a work surface engaged with housing 12. Turning to FIG. 2, there is shown internal volume 18 of housing 12. As can be seen, housing 12 includes a vacuum concentrator hose 28 stored within internal volume 18. Vacuum concentrator hose 28 includes a manifold 29 at first end thereof, for coupling to vacuum port 11. The other end 31 of vacuum concentrator hose 28 may be used to vacuum dust and other contaminants during use of dust containment apparatus 10, as described in further detail below.

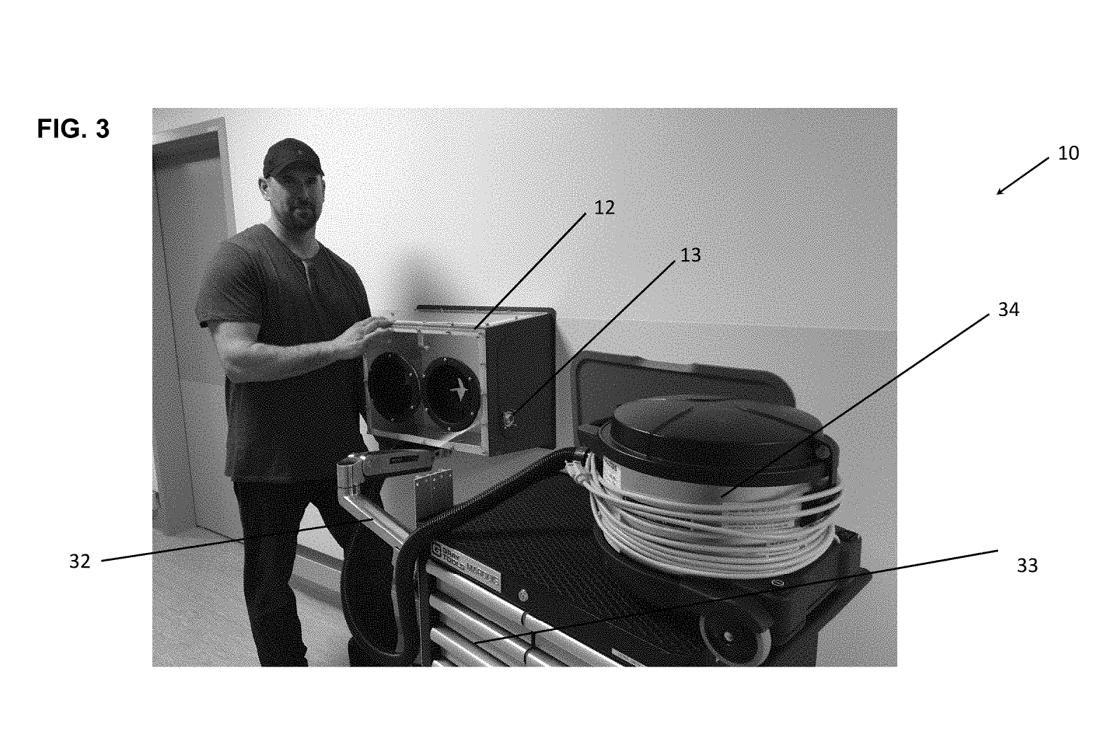

FIG. 3 shows another embodiment of dust containment apparatus 10 in which housing 12 is coupled to an articulating arm 32. Articulating arm 32 is connected to a movable platform 33. Movable platform 33 and articulating arm 32 are used to position housing 12 adjacent the work surface, and support housing 12 in place against the work surface. The coupling between articulating arm 32 and housing 12 may comprise a quick-release mechanism, and may be configured such that housing 12 may be positioned against the work surface in a variety of different angles. Movable platform 33 may store various tools and other equipment for use during work on the work surface. A vacuum device 34, such as a vacuum cleaner, is positioned on top of movable platform 33 and is coupled to vacuum port 11. As would be recognized by a person skilled in the art, other types of vacuum-generating devices may be used with housing 12. In some embodiments, a vacuum hose or conduit extending from vacuum device 34 may be introduced directly into internal volume 18, without being coupled to vacuum port 11. In such embodiments, vacuum port 11 may simply comprise a suitable aperture formed within housing 12, and vacuum hose 28 (FIG. 2) may be dispensed with. Movable platform 33 may include a brake for providing stability during maintenance work.

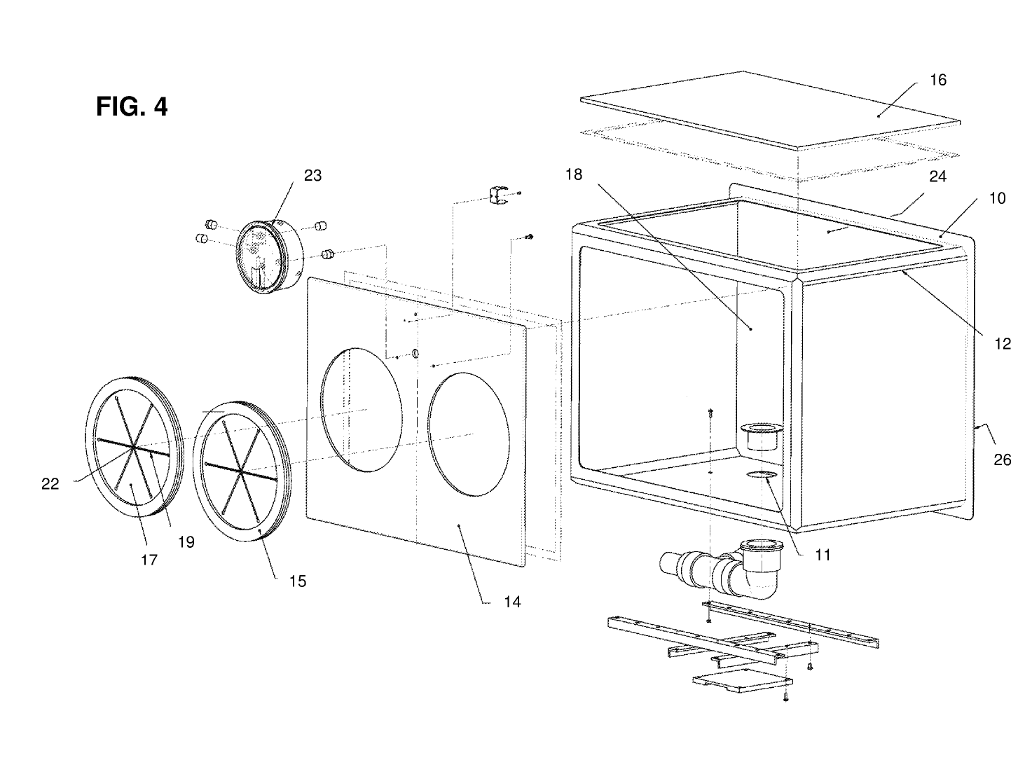

FIG. 4 shows another dust containment apparatus 10 according to embodiments of the disclosure. Dust containment apparatus 10 includes a pressure sensor and gauge 23 integrated within housing 12. Filters may also be provided with pressure sensor and gauge 23 to prevent dust transmission into pressure sensor and gauge 23. In some embodiments, pressure sensor and gauge 23 may comprise a Dwyer Instruments Magnehelic 2000. Other types of pressure sensors and gauges may be used. Furthermore, one or more alarms may be incorporated with the pressure sensor to alert a user should the negative pressure within internal volume 18 be too high (e.g. greater than 500 Pa, for example). Negative pressure may refer to the difference between atmospheric pressure and the pressure within internal volume 18.

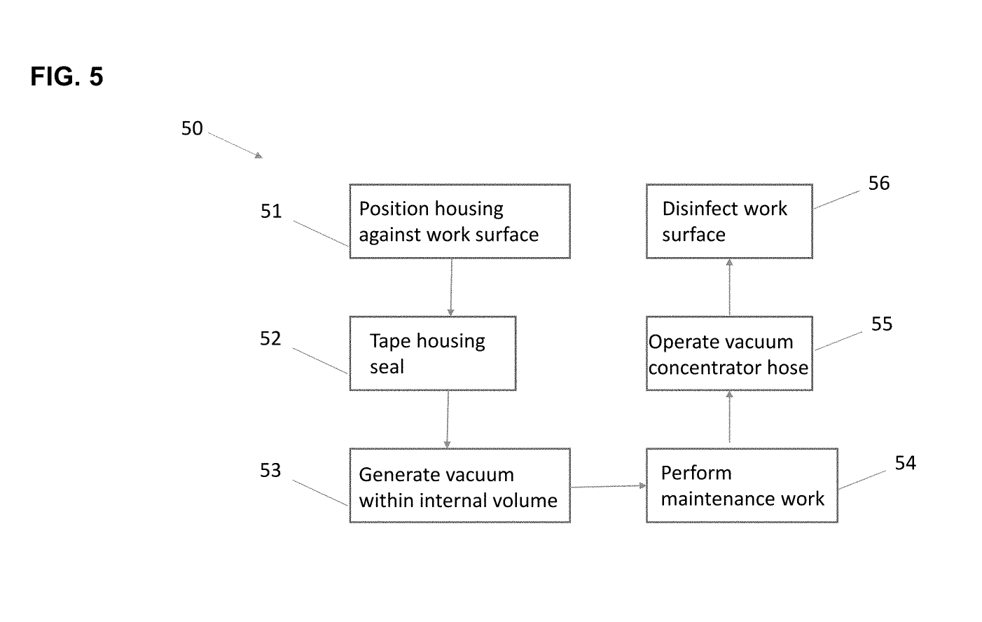

FIG. 5 shows an exemplary method of using dust containment apparatus 10. In some embodiments, steps may be omitted/added from the exemplary sequence shown in FIG. 5.

In use, at block 51, housing 12 is positioned against the work surface in need of maintenance work. For example, movable platform 33 and articulating arm 32 may be used to assist in the proper positioning and engagement of housing 12 against the work surface. For work surfaces where articulating arm 32 is not required (for example when maintenance work on the floor is required), housing 12 may be decoupled from articulating arm 32. Once housing seal 26 is flush against the work surface, at bock 52 the user applies an adhesive, such removable gaffer or painter's tape, around the perimeter of housing seal 26. The adhesive acts with housing seal 26 to form a positive, secure boundary between housing seal 26 and the work surface. The adhesive may additionally be applied along the interior joint of housing seal 26, within internal volume 18, to provide a triple-layer sealing. Such a triple-layer sealing may help avoid or limit dust incursion into any small cavities along the edges of housing seal 26 within internal volume 18.

At block 53, the user activates vacuum device 34 to generate a partial vacuum within internal volume 18. The pressure within internal volume 18 may be detected by a pressure sensor and displayed to the user via a pressure gauge. Thus, the user may determine whether the partial vacuum generated within internal volume 18 is sufficient to comply with, for example, infection control requirements, such as CSA Z317.13-17. During operation of vacuum device 34, fresh air enters housing 12 through hand ports 15 and vacuum limiter 13. In some embodiments, a minimum of 30 Pa of negative pressure must be indicated by the pressure gauge prior to commencement of dust-generating activities. In use, vacuum limiter 13 enables a second flow path to be opened between internal volume 18 and the exterior of housing 12. Thus, an operator may be protected from the collapse of housing 12.

At block 54, the user introduces one or more tools into internal volume 18 via hand ports 15. Deformable hand port seals 17 provide a partial seal between hand ports 15 and the user's arms and/or hands. At block 55, during use of the tools on the work surface, the user simultaneously vacuums any dust generated during the maintenance work by holding vacuum concentrator hose 28 adjacent the source of dust generation. Thus, any dust generated within internal volume 18 is likely to be rapidly aspirated. At block 56, once maintenance work is complete, the user may vacuum internal volume 18 to remove any residual dust. Vacuum concentrator hose 28 may then be unplugged from vacuum port 11 and stowed within housing 12. The interior of housing 12 and the work surface contained within internal volume 18 may then be disinfected, for example by using a disinfectant wipe. Vacuum may be supplied for an additional period thereafter, before disengaging housing 12 from the work surface.

In some embodiments, housing 12 may be attached to a bipod, tripod, or other extendable arm, to allow housing 12 to be positioned against elevated work surfaces. In some embodiments, elongate tools, such as concrete drills, may be operated from outside housing 12, with a portion of the tool (such as the drill bit) extending from outside housing 12 into internal volume 18, and into engagement with the work surface. In such embodiments, dust-generating work may be performed without the user having to introduce their hands within internal volume 18.

While the disclosure has been described in connection with specific embodiments, it is to be understood that the disclosure is not limited to these embodiments, and that alterations, modifications, and variations of these embodiments may be carried out by the skilled person without departing from the scope of the disclosure. It is furthermore contemplated that any part of any aspect or embodiment discussed in this specification can be implemented or combined with any part of any other aspect or embodiment discussed in this specification.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A dust containment apparatus comprising:
a housing comprising an opening and defining an internal volume;
a housing seal provided along an edge of the opening for sealing the housing against a work surface to be engaged with the housing; and
at least two hand ports provided in the housing for receiving a user's hands, wherein at least one of the hand ports comprises a deformable hand port seal for at least partially sealing against the user's arm or hand when inserted through the hand port into the internal volume, and wherein the deformable hand port seal comprises an aperture formed therein for allowing the user's hand to access the internal volume.

2. The apparatus of claim 1, wherein the housing further comprises a vacuum port for connecting to a vacuum device.

3. The apparatus of claim 2, further comprising a vacuum conduit for connecting to the vacuum port within the internal volume.

4. The apparatus of claim 2, further comprising a vacuum device for connecting to the vacuum port.

5. The apparatus of claim 1, further comprising a pressure sensor for reading a pressure within the internal volume.

6. The apparatus of claim 1, wherein the housing seal comprises a flange extending from the housing.

7. The apparatus of claim 1, wherein the housing is attached to an arm for supporting the housing in engagement with a work surface.

8. The apparatus of claim 8, wherein the housing is removably attached to the arm.

9. The apparatus of claim 8, wherein the arm is articulated.

10. The apparatus of claim 8, wherein the arm is supported by a movable platform for positioning the housing in engagement with a work surface.

11. The apparatus of claim 1, wherein the aperture comprises multiple slits formed within the deformable hand port seal.

12. The apparatus of claim 1, wherein the hand ports are removable from the housing.

13. The apparatus of claim 1, further comprising an adhesive for assisting the housing seal to seal against a work surface.

14. The apparatus of claim 13, wherein the adhesive comprises tape.

15. The apparatus of claim 1, further comprising a vacuum limiter for limiting a differential pressure between the internal volume and an exterior of the housing.

16. The apparatus of claim 1, wherein the housing seal comprises a closed-cell foam.

17. A method of performing work on a work surface, comprising:
providing a dust containment apparatus comprising:
a housing comprising an opening and defining an internal volume, wherein the housing further comprises a vacuum port for connecting to a vacuum device;
a housing seal provided along an edge of the opening for sealing the housing against a work surface to be engaged with the housing; and
at least two hand ports provided in the housing for receiving a user's hands, wherein at least one of the hand ports comprises a deformable hand port seal for at least partially sealing against the user's arm or hand when inserted through the hand port into the internal volume, and wherein the deformable hand port seal comprises an aperture formed therein for allowing the user's hand to access the internal volume;
engaging the opening with a work surface such that the housing seal seals against the work surface;
inserting one or more tools through the hand ports and into the internal volume;
performing work on the work surface using the one or more tools; and
vacuuming dust generated from the work by using a vacuum conduit coupled to the vacuum port within the internal volume.

18. The method of claim 17, wherein the vacuuming is performed simultaneously to the work.

19. The method of claim 17, further comprising, prior to performing the work, generating a vacuum within the internal volume by using a vacuum device coupled to the vacuum port.

20. The method of claim 17, further comprising applying an adhesive to the housing seal to assist the seal between the housing seal and the work surface.
